(19) United States
(12) Patent Application Publication
(10) Pub. No.: US 2016/0170868 A1
(43) Pub. Date: Jun. 16, 2016

(54) METHOD AND APPARATUS FOR THE AUTOMATED TESTING OF A SUBSYSTEM OF A SAFETY CRITICAL SYSTEM

(71) Applicant: SIEMENS AKTIENGESELLSCHAFT, Muenchen (DE)

(72) Inventors: Kai HOEFIG, Muenchen (DE); Marc ZELLER, Muenchen (DE)

(21) Appl. No.: 14/596,382

(22) Filed: Jan. 14, 2015

(30) Foreign Application Priority Data
Dec. 16, 2014 (EP) 14198094.6

(51) Int. Cl. G06F 11/36

(52) U.S. Cl. CPC G06F 11/3692; G06F 11/3684; G06F 11/3688

(57) ABSTRACT

A method for automated generation of at least one test pattern adapted to test a subsystem of a safety critical system comprising the steps of providing a failure propagation model of the safety critical system, selecting components of the subsystem under test as a test scope, and evaluating the test scope failure propagation model of the selected components to extract the test pattern.

### CROSS-REFERENCE TO RELATED APPLICATION

This application claims the priority, under 35 U.S.C. §119, of European patent application EP 14 198 094.6, filed Dec. 16, 2014; the prior application is herewith incorporated by reference in its entirety.

### BACKGROUND OF THE INVENTION

### Field of the Invention

The invention relates to a method and apparatus for automated generation of at least one test pattern adapted to test a subsystem of a safety critical system.

For safety critical systems, it is necessary to perform a testing of the system, in particular during its development. A safety critical system can be a complex safety critical system comprising a plurality of subsystems. The subsystems can comprise software and/or hardware components. Testing is performed during the development of the safety critical system to document the conformity of software components, hardware components or any other subsystems with the respective specification. Generating test cases is a critical task itself, since complex systems cannot be tested exhaustively due to the possible infinite state space. Instead, tests are performed for specific critical cases and different test scenarios are summarized to a single test case that represents the respective scenario (equivalence class test). Further, for complex systems, in particular safety critical systems, there is a risk to miss an important test case. Consequently, even every input on critical scenarios to the test cases helps to decrease this risk.

Fault tree analysis is used to analyze and document the causes of failures of safety critical systems. Fault tree analysis is a widely used method that enables a systematic top down analysis of the complex system. Typically, in a conventional fault tree analysis, assumptions about reactions of software and/or hardware components or any other subsystems of the entire safety critical system are made. These assumptions can be based on specifications, expert knowledge or tests and can provide reactions of the system (failures) to stimuli (causes). Thus, a fault tree can be seen as a specification about the failure behavior of the complex system. Since tests are performed against specifications, it is also possible to perform tests against fault trees. In this way, it can be shown that an actual behavior of the respective complex system is compliant to the fault tree. Since a system test of a safety critical system also aims at critical inputs, the results of the performed tests can be used to verify at least parts of the assumptions made about the system behavior within the fault tree.

However, combining fault trees and tests is not a simple task. The following problems can occur when fault trees are used as a source for a test input. The stimuli or causes that are used to model a contribution of a top event or failure of a fault tree are not in all cases stimuli that can be triggered by any test environment. For example, defective memory blocks are not a typical stimuli of software in a loop test. Further, most test environments aim at a certain component of a system, for example a hardware in the loop test for hardware test. Fault trees aim typically at the entire complex system. Therefore, it can be unclear which elements of the fault tree belong to the current test environment.

Accordingly, there is a need for a method and apparatus that uses component fault trees to generate test cases automatically for certain test environments.

### SUMMARY OF THE INVENTION

The invention provides according to a first aspect a method for automated generation of at least one test pattern adapted to test a subsystem of a safety critical system comprising the steps of:
providing a failure propagation model of the safety critical system,
selecting components of the subsystem under test as a test scope and
evaluating the test scope failure propagation model of the selected components to extract the test pattern.

In a possible embodiment of the method according to the first aspect of the present invention, the failure propagation model comprises a component fault tree model having component fault tree elements being related to corresponding components of the safety critical system.

In a further possible embodiment of the method according to the first aspect of the present invention, each component fault tree element of a component comprises output failure modes related to an outport of said component fault tree element and input failure modes related to an inport of said component fault tree element.

In a still further possible embodiment of the method according to the first aspect of the present invention, the output failure mode of a component fault tree element of a component corresponds to a top event of the respective component indicating a failure visible at the respective outport of the component fault tree element.

In a still further possible embodiment of the method according to the first aspect of the present invention, the component fault tree element of a component comprises an internal fault tree logic modeling a failure propagation from an inport of said component fault tree element to an outport of said component fault tree element depending on internal basic events.

In a still further possible embodiment of the method according to the first aspect of the present invention, the internal fault tree logic of a component fault tree element comprises logic gates.

In a further possible embodiment of the method according to the first aspect of the present invention, for each output failure mode a minimal cutset analysis is performed to extract a test pattern adapted to trigger the respective output failure mode of said component fault tree element.

In a further possible embodiment of the method according to the first aspect of the present invention, the generated test patterns are applied to the subsystem under test.

The invention further provides according to a second aspect a testing tool comprising a program having instructions for performing the test pattern generation, wherein the test pattern is adapted to test a subsystem of a safety critical system, wherein the test pattern is generated automatically by providing a failure propagation model of the safety critical system,
selecting components of the subsystem under test as a test scope and
evaluating the test scope failure propagation model of the selected components to extract the test pattern.

The invention further provides according to a third aspect a test system for testing a subsystem of a safety critical system comprising:
a first test pattern generator adapted to generate automatically a test pattern for said subsystem under test from a failure propagation model of said safety critical system stored in a memory and
a testing device adapted to apply the generated test pattern to inputs of the respective subsystem.

In a possible embodiment of the test system according to the third aspect of the present invention, the test system further comprises a second test pattern generator adapted to generate a test pattern for said subsystem under test from a specification of said subsystem.

In a further possible embodiment of the test system according to the third aspect of the present invention, the failure propagation model stored in the memory comprises a fault tree model having component fault tree elements related to corresponding components of the safety critical system.

In a further possible embodiment of the test system according to the third aspect of the present invention, the first pattern generator comprises a calculation unit adapted to perform the test pattern generation method according to the first aspect of the present invention.

The invention further provides according to a fourth aspect a safety critical system consisting of subsystems testable by a test system according to the third aspect of the present invention.

In a possible embodiment of the safety critical system according to the fourth aspect of the present invention, the safety critical system is a safety critical embedded system comprising hardware components and/or software components.

Other features which are considered as characteristic for the invention are set forth in the appended claims.

Although the invention is illustrated and described herein as embodied in a method and apparatus for the automated testing of a subsystem of a safety critical system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a block diagram of a possible exemplary embodiment of a test system for testing a subsystem of a safety critical system according to an aspect of the present invention;

FIG. 2 shows a schematic testing environment with classic test cases from a specification, test cases from component fault trees and a subsystem to be tested for illustrating a possible exemplary embodiment of the test system according to an aspect of the present invention;

FIG. 3 shows a flowchart of a possible exemplary embodiment of a method for automated generation of at least one test pattern according to a further aspect of the present invention;

FIGS. 4, 5 show a classic fault tree and a component fault tree for illustrating the operation of the method and apparatus according to the present invention;

FIG. 6 illustrates an example model using component fault trees and a testing scope to illustrate the operation of a method and apparatus according to an aspect of the present invention;

FIG. 7 illustrates a component fault tree for the testing scope as defined in FIG. 6.

### DETAILED DESCRIPTION OF THE INVENTION

FIG. 1 shows schematically a block diagram for illustrating a possible exemplary embodiment of a test system 1 for testing a subsystem 2 of a safety critical system, SCS. The subsystem 2 of such a safety critical system, SCS, can be a subsystem comprising hardware and/or software components of a safety critical complex system. A safety critical system, SCS, can be a safety critical embedded system comprising a plurality of hardware and/or software components. As illustrated in FIG. 1, the test system 1 has access to a database or memory 3 which stores a failure propagation model, FPM, of the safety critical system, SCS. The test system 1 has a first test pattern generator 1A adapted to generate automatically a test pattern for the subsystem 2 under test from the failure propagation model, FPM, of the safety critical system, SCS, stored in the memory 3. The test system 1 further comprises a testing device 1B adapted to apply the generated test pattern, TP, to inputs of the respective subsystem 2.

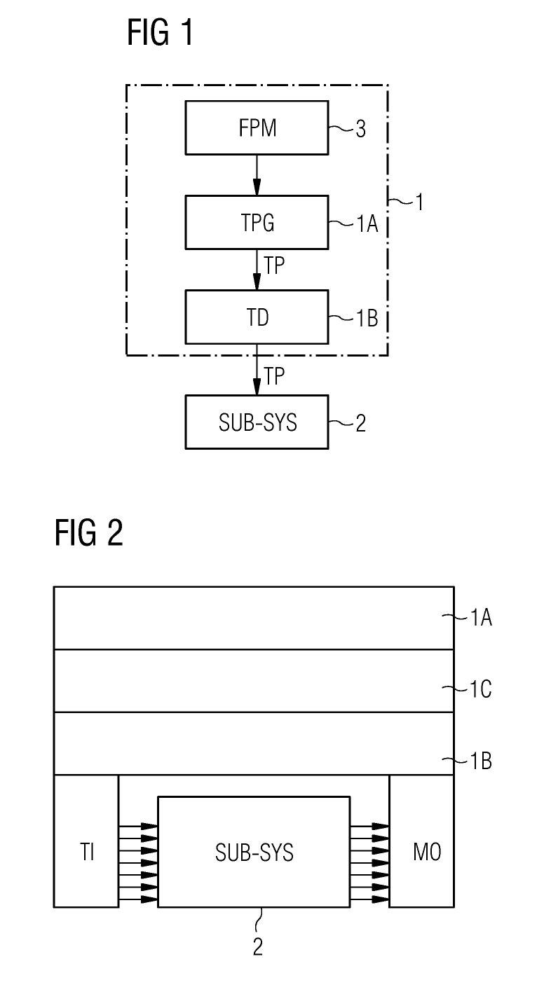

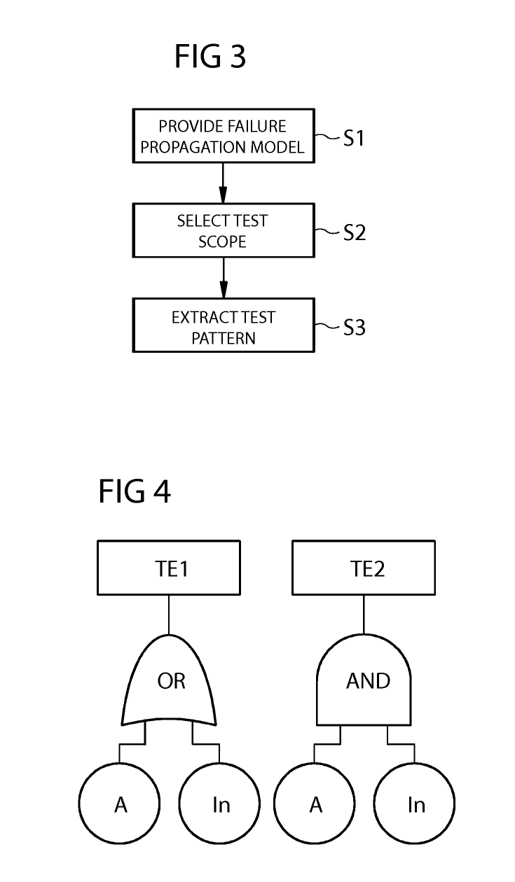

FIG. 2 shows a further exemplary embodiment of the test system 1 according to an aspect of the present invention. The test system 1 forms a testing environment with classic test cases from the specification, test cases from component fault trees, CFT, and a part of a system to be tested, the testing scope. The test system 1 as illustrated in FIG. 2 can comprise a unit testing tool to obtain a modified condition decision coverage information. The test cases generated by the test system 1 as illustrated in FIG. 2 can comprise additional test cases of classic tests which are derived from the specification of the system. In the embodiment of the test system 1 as illustrated in FIG. 2, the test system comprises a first test pattern generator 1A and a second test generator 1C connected to a test environment or testing device 1B. The first test pattern generator 1A is adapted to generate automatically a test pattern, TP, for the subsystem 2 under test from a failure propagation model, FPM, of the respective safety critical system, SCS, stored in a database or memory 3. The second test pattern generator 1C is adapted to generate a test pattern, TP, for the same subsystem 2 under test from a specification of the subsystem 2. The test pattern generators 1A, 1C are connected to a test environment or testing device 1B that applies trigger inputs, TI, as test pattern to the subsystem 2 under test and receives measured outputs from the subsystem 2 under test as illustrated in FIG. 2. In the test system 1 as shown in FIG. 2, the failure modes to be tested can be automatically generated from component fault trees, CFT, and can be either matched to existing test cases or provide additional test cases to be defined, e.g. by defining the inputs to be triggered and the corresponding outputs to be measured. The test system 1 as illustrated in the embodiments of FIGS. 1 and 2 and the method as illustrated in the flowchart of FIG. 3.

FIG. 3 shows an exemplary embodiment of a method for automated generation of at least one test pattern, TP, according to a further aspect of the present invention. The method for automated generation of at least one test pattern as shown in FIG. 3 is adapted to test a subsystem of a safety critical system, SCS, for instance a subsystem 2 as shown in FIGS. 1, 2. In a first step S1, a failure propagation model, FPM, of the safety critical system, SCS, to be investigated is provided. The failure propagation model, FPM, can be stored in a memory or in a database. In a further step S2, the components of the subsystem 2 under test are selected as a test scope. In a further step S3, the test scope failure propagation model of the selected components is evaluated to extract the test pattern. The extracted test pattern, TP, is then applied by a testing device 1B to the respective subsystem 2. The failure propagation model, FPM, provided in step S1 of the method as shown in FIG. 3 can comprise a component fault tree, CFT, model having component fault tree elements being related to corresponding components of the safety critical system, SCS. Each component fault tree element of a component can comprise output failure modes selected to an outport of the component fault tree element and input failure modes related to an inport of the component fault tree element. The output failure mode of a component fault tree element of a component corresponds to a top event, TE, of the respective component indicating a failure visible at the respective outport of the component fault tree element. The component fault tree element of a component can comprise an internal fault tree logic modeling a failure propagation from an inport of said component fault tree element to an outport of said component fault tree element depending on internal basic events, BE. In a possible embodiment, the internal fault tree logic of a component fault tree element can comprise logic gates. In a possible embodiment, for each output failure mode, a minimal cutset analysis, MCA, is performed to extract a test pattern, TP, adapted to trigger the respective output failure mode of the component fault tree element. Finally, the generated test patterns, TP, are applied to the subsystem 2 under test.

The component fault tree, CFT, as used by the method and apparatus according to the present invention is a Boolean data model associated to system development elements such as components. The components can comprise hardware and/or software components. The component fault tree, CFT, has the same expressive power as a classic fault tree as described for instance in William Vesely, Joanne Dugan, Joseph Fragola, Joseph Minarick, and Jan Railsback “Fault Tree Handbook with Aerospace Applications”, 2002. NASA Office of Safety and Mission Assurance. In Bernhard Kaiser, Peter Liggesmeyer, and Oliver Mackel “A new component concept for fault trees”, in SCS '03: Proceedings of the 8th Australian workshop on safety critical systems and software, pages 37-46, Darlinghurst, Australia, 2003. Australian Computer Society, Inc., a component fault tree, CFT, is described. Similar to classic fault trees, component fault trees, CFT, are also used to model failure behavior of safety critical systems, SCS. This failure behavior is used to document that a complex system is safe and can also be used to identify drawbacks of the design of such a system. A separate component fault tree element can be associated to any hardware and/or software component of the system. Failures that are visible at an outport of the component are modeled using output failure modes which are related to the specific outport. To model how specific failures propagate from an inport of a component to the outport, input failure modes are used. The inner failure behavior that also influences the output failure modes is modeled using gates such as a NOT gate, an AND gate, an OR gate and by using basic events, BE. Every component fault tree, CFT, can be transformed into a corresponding classic fault tree by removing the input and output failure mode elements.

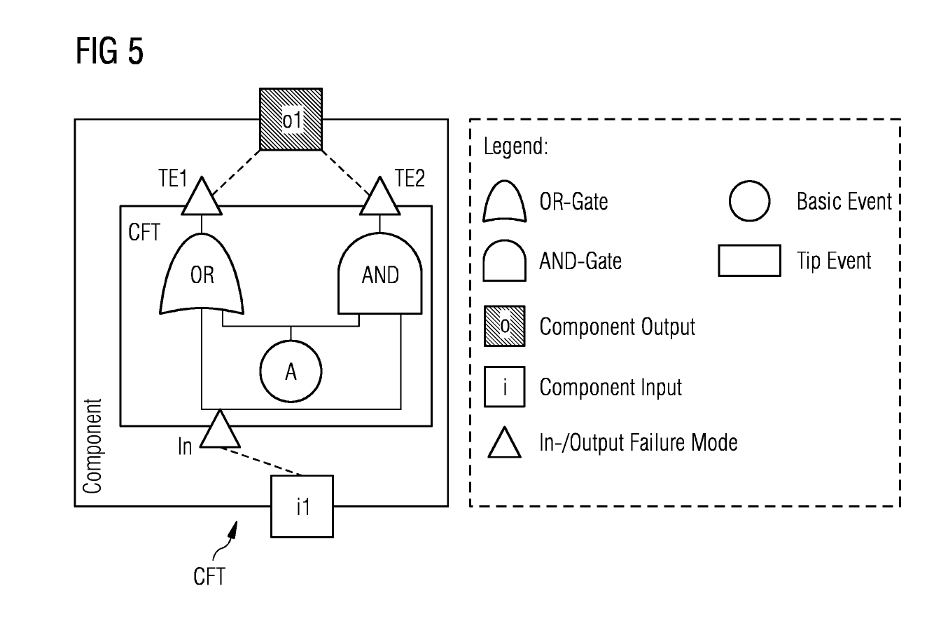

FIG. 4 shows a classic fault tree and FIG. 5 shows a corresponding component fault tree, CFT. In both trees as illustrated in FIGS. 4, 5, the top events, TE, or output events TE1, TE2 are modeled. The component fault tree model allows additionally to the Boolean formulae that are also modeled within the classic fault tree to associate the specific top events, TE, to the corresponding ports where these failures can appear. For example, in FIG. 5, top event TE1 appears at port O1. By using this methodology of components also within fault tree models, benefits during the development of the system can be observed, for example an increased maintainability of the respective safety analysis model.

In the following, it is described how component fault trees, CFTs, are used to derive tests within a specific scope.

With C=c₁ . . . , cₙ being the set of components of a system and CFT=cft₁, . . . , cftₘ∪φ being the set of component fault trees

C\tilde{F}T(c)=cft,c∈C,cft∈CFT.

With

IN(c)=in₁, . . . , inᵢ, and OUT(c)=out₁, . . . , outⱼ

being the in- and outports of a component c and

C̅O̅N̅={(out,in)|out∈OUT(c₁)∪ . . . OUT(cₙ), (1)

in∈IN(c₁)∪ . . . ∪IN(cₙ)} (2)

being the set of all possible port connections and

CON⊂C̅O̅N̅

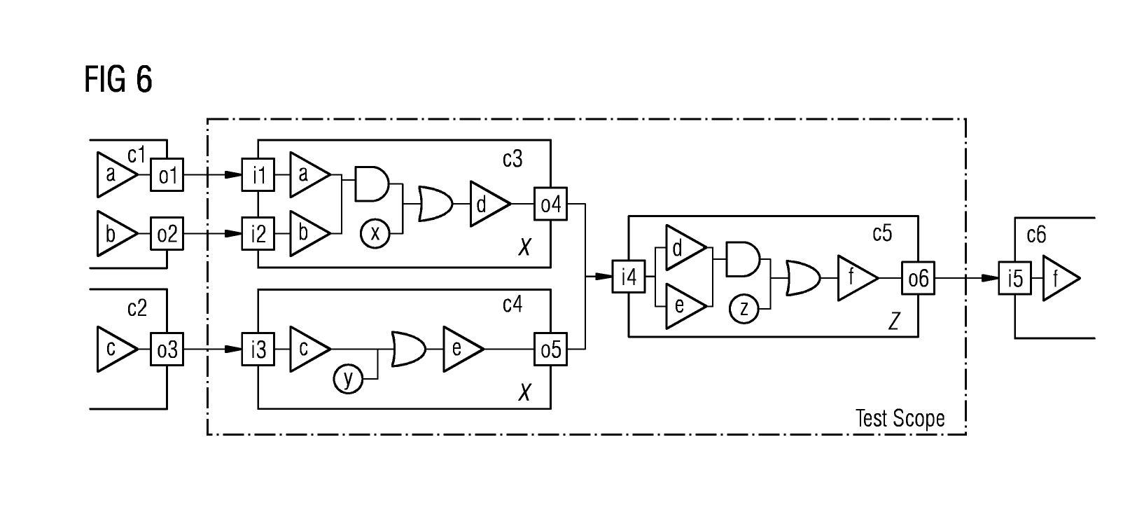

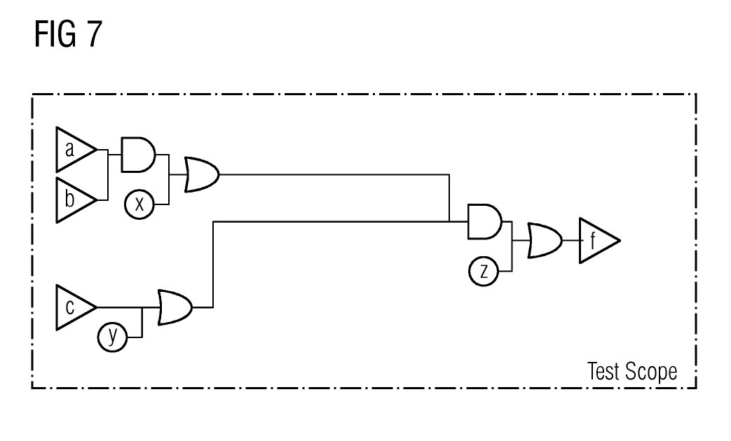

being the set of actual port connections modeling the data flow from the outport of a first component to the inport of another second component. For the purposes of testing, a testing scope can be defined that involves some of the components with S⊂ C, since tests cover in most cases only a part of the system, e.g. a specific piece of hardware. In the example system depicted in FIG. 6, the relevant sets as defined above are:

C=c₁,c₂,c₃,c₄,c₅,c₆ (3)

S=c₃,c₄,c₅ (4)

CFT(c₃)=X (5)

CFT(c₄)=Y (6)

CFT(c₅)=Z (7)

OUT(c₁)=o₁,o₂ (8)

OUT(c₂)=o₃ (9)

OUT(c₃)=o₄ (10)

OUT(c₄)=o₅ (11)

OUT(c₅)=o₅ (12)

IN(c₃)=i₁,i₂ (13)

IN(c₄)=i₃ (14)

IN(c₅)=i₄ (15)

IN(c₆)=i₅ (16)

CON=(o₁,i₁),(o₂,i₂),(o₃,i₃), (17)

=(o₄,i₄),(o₅,i₄),(o₆,i₅) (18)

The testing scope defined in the set S provides a set of inputs and outputs that are used for testing. The inputs of the test scope, here i₁, i₂, i₃, are used to enter a test scenario. The outputs are used to measure the results of a test scenario, o₆ in the exemplary system.

If a component c has a component fault tree, CFT, then it is

C\tilde{F}T(c)=cft,cft≠φ.

If a component c has input and output failure modes, it is

IFM(in)≠{ } and OFM(out)≠{ }

for an inport in∈IN(c) and an outport out∈OUT(c). In the example system as depicted in FIG. 6, the input and output failure modes related to the ports are:

OFM(o₁)=a (19)

OFM(o₂)=b (20)

OFM(o₃)=c (21)

OFM(o₄)=d (22)

OFM(o₅)=e (23)

OFM(o₆)=f (24)

IFM(i₁)=a (25)

IFM(i₂)=b (26)

IFM(i₃)=c (27)

IFM(i₄)=d,e (28)

IFM(i₅)=f (29)

If all components c have component fault trees, CFTs, and the data model is used in a proper way, all input and output failure modes can be connected with each other by using the connections defined in CON. The inner component fault tree logic can be simplified to a component fault tree, CFT, for the testing scope that only contains the gates and basic events, BE, input and output failure modes that are related to the test scope. FIG. 6 shows this component fault tree, CFT, for the testing scope as defined in FIG. 5.

For a test scope S⊂C, the component fault tree, CFT, related to S is CFT_{S}. It has the failure modes that are related to the inports and outports that have a connection outside of the test scope. With

IFM(S)={in|∃(a,b)∈CON N, (30)

a∈OUT(A),A∉S, (31)

b∈IN(B),B∉S, (32)

in∈IFM(B)} (33)

being the input failure modes of the test scope and

OFM(S)={out|∃(a,b)∈CON N, (34)

a∈OUT(A),A∉S, (35)

b∈IN(B),B∉S, (36)

out∈OFM(A)} (37)

being the output failure modes of the testing scope S in the example system depicted in FIG. 6, the sets for the failure modes of the testing scope depicted in FIG. 5 are:

IFM(S)=a,b,c (38)

OFM(S)=f. (39)

Since the events X, Y, Z as depicted in FIG. 6 are internal, they can, in general, not be triggered via the inports of the testing scope. Therefore, only failure views can be triggered at the outports of the testing scope that depend on inputs. In a possible embodiment, the methodology of minimal cutset analysis, MCA is applied. A minimal cutset analysis, MCA, is a representation of a tree using a disjunction of conjunctive terms that cannot be reduced further. The minimal cutset analysis, MCA, for the top event f depicted in FIG. 6 is:

f [symbol] (âb̂c)ν(x̂c)ν(âb̂y)ν(x̂y)ν (z)

As can be seen from the minimal cutset analysis, MCA, of the only top event, TE, that is related to OFM(S), there is only one cutset that triggers the top event, TE, which is entirely dependent on input failure modes of the testing scope, (a, b, c). The other cutsets cannot be triggered from outside the testing scope since they contain at least one internal event of the testing scope.

For a testing scope S,

mcᵢ(t)=x₁̂ . . . ̂xₙ, (40)

t∈(OFM(S), (41)

xᵢ∈IFM(S)∪Internal Events (42)

with

MCA(t)=mc₁(t)̂ . . . ̂mcₘ(t),t∈OFM(S)

being the minimal cutset analysis, MCA, of the output failure mode f of the testing scope S, then

TEST_{S}(t)={mc|mc∈MCA(t), (43)

mc=x₁̂ . . . ̂xₙ, (44)

∀i=1, . . . ,n:xᵢ∈IFM(S)} (45)

being the set of cutsets that trigger t from the input failure modes of the testing scope S. If the output failure modes OFM(S) of S can be measured or observed at the outports of S, test cases can be generated that trigger these output failure modes if they depend (at least with one cutset) on the inputs given via IFM(S). For the input and output failure modes, matching functional input and output combinations can be assigned to the failure modes for testing. Since, in general, multiple combinations of input data leads to different output data for the same test case, typical measures can be applied to further reduce the set of test cases like equivalence class testing. If the inputs that correspond to the input failure modes of S lead to outputs that correspond to the output failure modes of S, the test is performed successfully under this testing scenario. If the inputs that correspond to the input failure modes of S do not lead to outputs that correspond to the output failure modes of S, the test has failed under this testing scenario.

1. A method for automated generation of at least one test pattern adapted to test a subsystem of a safety critical system comprising the steps of:
(a) providing a failure propagation model of the safety critical system;
(b) selecting components of the subsystem under test as a test scope; and
(c) evaluating the test scope failure propagation model of the selected components to extract the test pattern.

2. The method according to claim 1, wherein the failure propagation model comprises a component fault tree model having component fault tree elements being related to corresponding components of the safety critical system.

3. The method according to claim 2, wherein each component fault tree element of a component comprises:
output failure modes related to an outport of said component fault tree element; and
input failure modes related to an inport of said component fault tree element.

4. The method according to claim 3, wherein the output failure mode of a component fault tree element of a component corresponds to a top event of the respective component indicating a failure visible at the respective outport of the component fault tree element.

5. The method according to claim 2, wherein the component fault tree element of a component comprises an internal fault tree logic modeling a failure propagation from an inport of said component fault tree element to an outport of said component fault tree element depending on internal basic events.

6. The method according to claim 5, wherein the internal fault tree logic of a component fault tree element comprises logic gates.

7. The method according to claim 4, wherein for each output failure mode a minimal cutset analysis, MCA, is performed to extract a test pattern adapted to trigger the respective output failure mode of said component fault tree element.

8. The method according to claim 1, wherein the generated test patterns are applied to the subsystem under test.

9. A testing tool comprising a program having instructions for performing the test pattern generation method according to claim 1.

10. A test system for testing a subsystem of a safety critical system comprising:
a first test pattern generator adapted to generate automatically a test pattern for said subsystem under test from a failure propagation model of said safety critical system stored in a memory and
a testing device adapted to apply the generated test pattern to inputs of the respective subsystem.

11. The test system according to claim 10 comprising a second test pattern generator adapted to generate a test pattern for said subsystem under test from a specification of said subsystem.

12. The test system according to claim 10, wherein the failure propagation model stored in said memory comprises a fault tree model having component fault tree elements related to corresponding components of said safety critical system.

13. The test system according to claim 10, wherein the first pattern generator comprises a calculation unit adapted to perform the test pattern generation method according to claim 1.

14. A safety critical system consisting of subsystems testable by a test system according to claim 10.

15. The safety critical system according to claim 14, wherein the safety critical system is a safety critical embedded system comprising hardware components and/or software components.
